(19) United States
(12) Patent Application Publication
(10) Pub. No.: US 2007/0269034 A1
(43) Pub. Date: Nov. 22, 2007

(54) Time difference notification in a cell phone system

(76) Inventor: Stanley M. Schurgin, Boston, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/800,338

(22) Filed: May 4, 2007

Related U.S. Application Data
(60) Provisional application No. 60/800,646, filed on May 16, 2006.

(51) Int. Cl. H04M 3/42

(52) U.S. Cl. 379/207.03

(57) ABSTRACT

A system and method is provided for notifying a calling party that the called party's cell phone is located in a time zone different from the time zone of the calling party or that there is a time difference between the calling party's local time and the local time of the called party at the time of the call. Based upon the notification of time or time zone difference, the calling party has the opportunity of discontinuing the call to not disturb the called party at a time deemed to be inconvenient. If the call is considered urgent, the calling party can elect to continue with the call even with the noted time difference. Alternatively, the time difference notification can be provided to the calling party only if the time difference between that of the calling party and called party is greater than a predetermined amount.

### CROSS REFERENCE TO RELATED APPLICATIONS

This application claims the priority of U.S. Provisional Application No. 60/800,646filed May 16, 2006 entitled, CELL PHONE SYSTEM HAVING TIME NOTIFICATION, the whole of which is hereby incorporated by reference herein.

### STATEMENT REGARDING FEDERALLY SPONSORED RESEARCH OR DEVELOPMENT

N/A

### BACKGROUND OF THE INVENTION

Cell phone users may travel with their phones throughout the United States or to other countries having different time zones. A call placed to a cell phone user who, at the time of the call, is in a different time zone than the calling party will be received by the called party at what may be an inconvenient time, such as early in the morning or late at night. For example, a calling party in the Eastern time zone may place a call to a called party who is in the Pacific time zone, which is 3 hours earlier than the Eastern time zone. A call placed at 8:00 a.m. Eastern time would be received at 5:00 a.m. Pacific time, which may well be too early for conveniently receiving a call. As another example, a call placed by a calling party in the Eastern time zone to a called party in a country in Central Europe would have a time displacement of six hours ahead of the Eastern time zone. Thus, a call placed at 6:00 p.m. Eastern time would be received at midnight Central European time. The calling party may not know that the called party is outside of his or her usual calling area and thus not know that the call is being received at an inconvenient time by reason of the time difference between the time zone of the calling party and that of the called party.

It would be beneficial to have a system and method by which a calling party can be notified of the time difference between the time zones of the calling and called parties.

### BRIEF SUMMARY OF THE INVENTION

In accordance with the invention, a system and method is provided for notifying a calling party that the called party's cell phone is located in a time zone different from the time zone of the calling party or that there is a time difference between the calling party's local time and the local time of the called party at the time of the call. Based upon the notification of time or time zone difference, the calling party has the opportunity of discontinuing the call to not disturb the called party at a time deemed to be inconvenient. If the call is considered urgent, the calling party can elect to continue with the call even with the noted time difference.

Known cellular telephone systems, also called mobile or wireless telephone systems, have the capability of determining the location within a cellular network of a user's cell phone. The ability of a cell phone user to roam outside of the user's home network is facilitated by this capability. According to the invention, a call made by a calling party to a called party is received by the cellular system where the called party is then located, and a time indication of the local time of the called party at the time of the call is sent from the cellular system serving the called party to the calling party. The time indication can be, for example, by a display of the called party's local time or by a suitable message on the calling party's cell phone, or by an audible message. In an alternative embodiment, the time indication can be signaled to the calling party without necessarily indicating the time difference or the local time of the called party. For example, an audible beep or tone, or a message displayed on the calling party's phone, or other audible, visual or vibratory indication, can be provided to the calling party to signify that the local time of the called party is not convenient for receipt of the call. The calling party can have the choice to proceed with the call or to discontinue the call. Typically, the call can be caused to proceed by the calling party pushing the talk or send button on the cell phone of the calling party.

In another aspect of the invention, the called party can specify a local time period in which calls will not be answered or completed. For example, a called party can specify the hours of 10:00 p.m. to 7:00 a.m. at the location of the called party in which calls are not wanted. A call to the called party during the specified time period from a calling party in a different time zone can either be discontinued upon an indication to the calling party of the time difference, or can be diverted to a voicemail unit.

The call from a calling party can be by a cell/wireless phone or a landline phone.

The system can be arranged such that no time notification is provided to the calling party if the called party is in the same time zone as the calling party, or if the called party is in a time zone within a tolerable time difference from the time zone of the calling party. For example, if the time zone difference between that of the calling party and called party is 2 hours or less, the system can be programmed and arranged to not provide an indication of time difference to the calling party.

### BRIEF DESCRIPTION OF THE SEVERAL VIEWS OF THE DRAWINGS

The invention will be more fully understood from the following detailed description taken in conjunction with the drawing in which:

FIG. 1 is a block diagram of a telephone network in which the invention is used;

FIG. 2 is a flowchart illustrating the operation of the invention;

FIG. 3 is a flowchart illustrating one mode of operation of the invention; and

FIG. 4 is a flowchart illustrating another mode of operation of the invention.

### DETAILED DESCRIPTION OF THE INVENTION

This application claims the priority of U.S. Provisional Application No. 60/800,646 filed May 16, 2006 entitled, CELL PHONE SYSTEM HAVING TIME NOTIFICATION, the whole of which is hereby incorporated by reference herein.

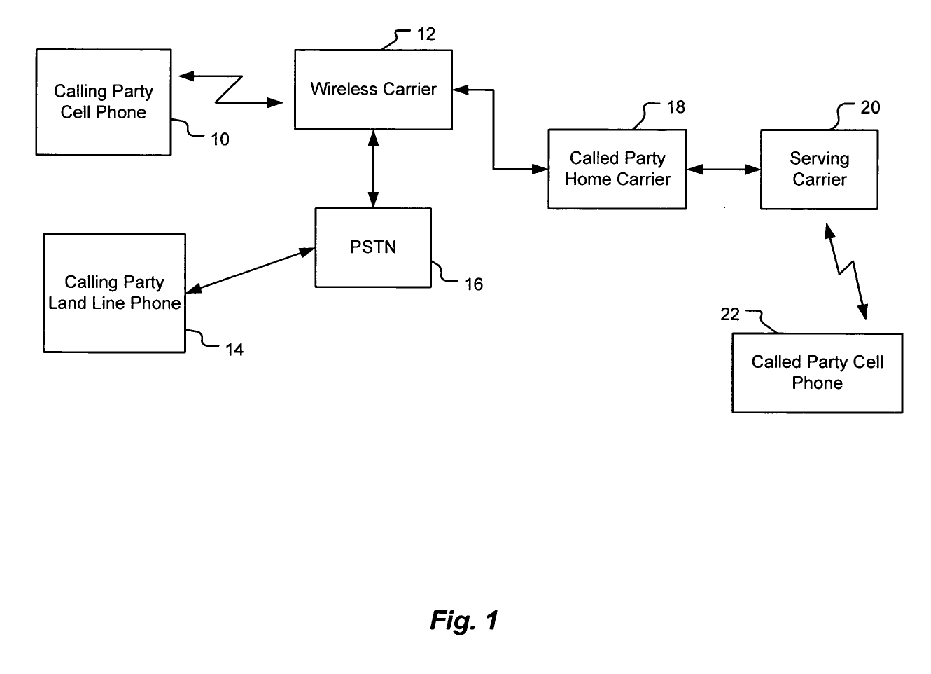

A telephone system in which the invention is used and which is operative in accordance with the invention is illustrated in FIG. 1. A calling party cell phone 10 is in wireless communication with a wireless or cellular carrier 12, which may be the home carrier of the calling party or another serving carrier if the calling party is “roaming”. A calling party landline phone 14 is in communication with a public switched telephone network (PSTN) 16 which is also in communication with the wireless carrier 12. The wireless carrier 12 is in communication with the called party home carrier 18 which, in turn, is in communication with the serving carrier 20 of the area in which a called party is then located. The serving carrier is in wireless communication with the called party cell phone 22.

As seen from FIG. 1, a call can be made by a calling party using either a cell phone 10 or a landline phone 14. In the case of a call from a landline phone, the call is conveyed via the public switched telephone network and thence through one or more wireless carriers to the cell phone 22 of the called party. For a call originating from a cell phone 10, the call is directed by one or more wireless carriers, such as carriers 12, 18 and 20, to the called party cell phone 22.

The telephone system operation for placing and receiving calls to and from landline phones and cell phones is well known and is not described in detail herein. Known cellular or wireless telephone systems have the capability of determining the location of a user's cell phone within a cellular or wireless network. When a user initiates a call, the switching equipment of the receiving mobile switching center (MSC) determines whether or not the call is from the home area of the calling cell phone, by querying a home location register (HLR) which is the main database of subscriber information for a mobile network. If the user is outside of the home area, that is, the user is “roaming”, the mobile switching center sends a query on the telephone network to identify the location of the called party. The called party location is stored in the visiting location register (VLR) of the MSC of the carrier serving the called party. Routing information is communicated between the mobile switching centers of the calling and called parties to establish a connection for a call to be completed. Communications between the network elements are typically based on SS7 protocols and signaling. Local time is usually indicated on the cell phone of a user based upon time information provided by the local wireless provider.

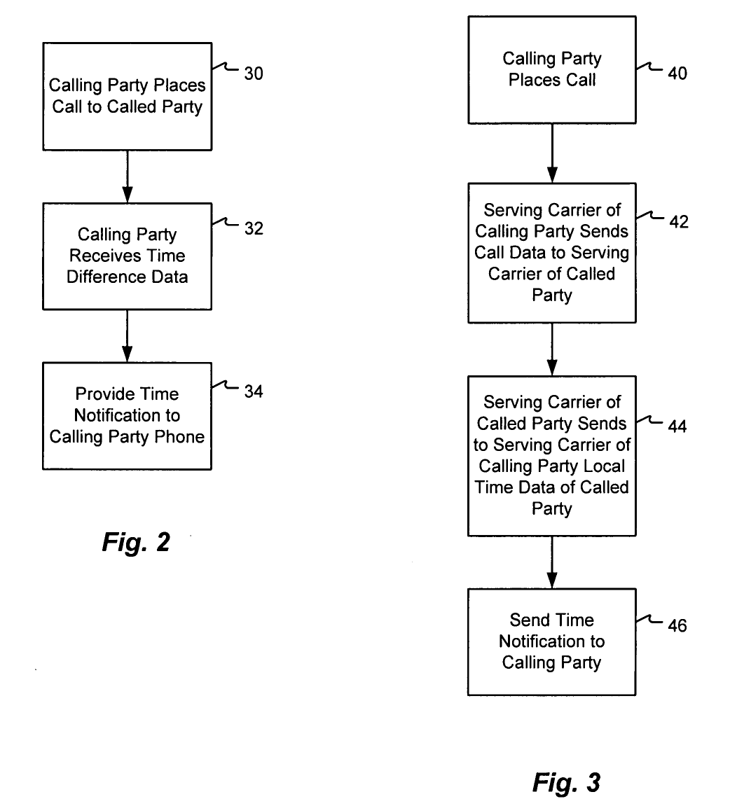

The invention in basic form is illustrated in FIG. 2. A calling party places a call to a called party, as noted in block 30. Time difference data representing the difference between the local time at the called party phone location and the local time at the calling party phone location is received at the calling party phone, as shown in block 32. A time notification is provided to the calling party phone, as shown in block 34. The time notification can be an indication of the time difference between the local times of the calling and called parties, or can be an indication of the actual local time of the called party.

In accordance with the invention, when a call to the called party is placed, the local time at the location of the called party is signaled via the telephone network to the calling party, or a time difference is signaled to the calling party. The time or time difference indication is provided to the calling party phone. A procedure is established within the cellular network for providing time difference information or other predetermined time information from the called party location to the calling party. The time information can be provided using the usual data or control channels and protocols of the telephone network, such as the SS7 system. The time difference information can be part of a user profile or other database of call features for the user, or the time difference information and notification procedures can be made a part of the regular features provided by a carrier to its users. The time indication can be provided in the form of actual notation of the time, such as by a visual and/or audible time message, at the calling party's phone. Alternatively, the time indication can be provided in the form of a notification of a time difference or time zone difference between that of the called party and the calling party. As a further alternative, audible, visual, vibratory or other warnings can be provided to the calling party to notify the calling party that the called party is then in a different time zone. Such a warning indication can be provided alone or in combination with a visual message and/or an audible message. For example, a time difference notification can be provided by a message on the calling party's cell phone display and an audible beep provided to alert the user of the message.

FIG. 3 is a flowchart illustrating one mode of operation in accordance with the invention. In block 40, a calling party places a call. In block 42, the serving carrier of the calling party sends call data to the serving carrier of the called party. In block 44, the serving carrier of the called party sends to the serving carrier of the calling party time data denoting the local time at the called party location. In block 46, a time notification is sent to the calling party. The type of time notification being provided to a calling party can be determined in accordance with the time difference notification features provided by the applicable wireless carrier or carriers. These features may be selectable by the users or provided as part of standard features provided by the carrier. The exact manner of communicating the time difference data from the serving carrier of the called party to the serving carrier of the calling party is dependant upon the configuration of the interoperable wireless carrier networks and the particular protocols adopted to provide the time data and notification. The manner of providing particular telephone signaling and the provision of data over wireless telephone networks is well understood by persons of ordinary skill in the art.

The system can be arranged to provide an indication of time difference any time there is a difference in time zone between the calling and called parties, which is typically a time difference of one hour or more. In an alternative implementation, the system can be arranged to provide a time difference notification only if there is more than a predetermined time difference between that of the calling and called parties. For example, the system can be programmed and arranged to provide a time difference notification if there is a time difference of greater than three hours between the calling and called party time zones.

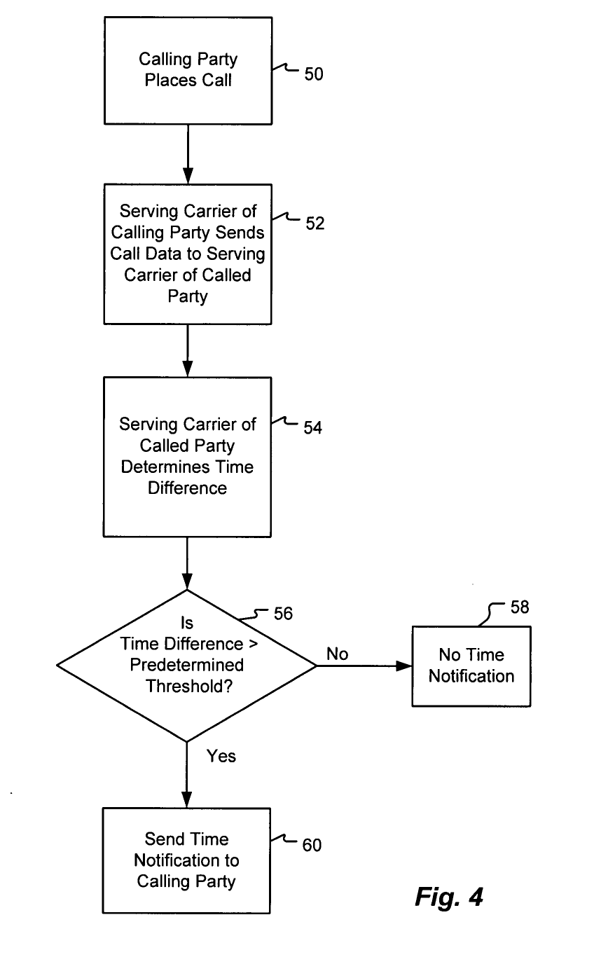

The alternative implementation just described is illustrated in the flowchart of FIG. 4. In block 50, a calling party places a call. In block 52, the serving carrier of the calling party sends call data to the serving carrier of the called party. In block 54, the serving carrier of the called party determines the time difference between the local time of the called party and the local time of the calling party, at the time of the call. In block 56, a determination is made whether the time difference is greater than a predetermined time difference threshold, shown in FIG. 3 as 3 hours. If the time difference is not greater than the predetermined threshold, which in the illustration is 3 hours, no time notification is provided to the calling party, as denoted by block 58. If the time difference is greater than the predetermined threshold, a time notification is sent to the calling party, as shown in block 60.

Based on the time indication, the calling party can have the choice to proceed with the call or to discontinue the call. The call can be caused to proceed typically by the calling party pushing the talk or send button, in the case of a calling party using a cell phone. In the case of a calling party using a landline phone, the call can be caused to proceed by the calling party pushing a predetermined key on the phone.

A called party may choose to not receive calls during predetermined times that the called party considers inconvenient. In this circumstance, the telephone system can be arranged such that the calling party attempting to place a call to the called party during the predetermined times will receive an indication that the call cannot be completed or can receive a more specific message that the call cannot be completed because the called party does not wish to receive calls at that time. Voicemail options may be provided in the conventional manner so that a calling party will have the opportunity of leaving a voice message for a call which is not answered by the called party.

The distributed nature of telephone systems and networks permits the functionality of the present invention to be implemented in a variety of ways and at a variety of locations within the system or network. The provision of called party time data can be programmed at the MSC serving the called party, or at the MSC of the called party's home carrier, or other location in or associated with the network. Alternatively, local time data can be stored in the called party phone such as via a SIM card for example. The time data can be associated with or part of the user profile or preferences of the called party, and this time data can be accessed and employed in accordance with data protocols of telephone systems and networks which are per se known in the art.

The invention is not to be limited by what has been particularly shown and described but is to encompass the full spirit and scope of the invention as set forth in the appended claims.

What is claimed is:

1. A method of time difference notification in a cell phone system comprising the steps of:
placing a telephone call from a calling party phone to a cell phone of a called party;
receiving at the calling party phone, data representing a time difference between the local time of the called party and the local time of the calling party; and
providing on the calling party phone an indication of the time difference.

2. The method of claim 1 wherein the placing step includes placing a telephone call from a calling party cell phone.

3. The method of claim 1 wherein the placing step includes placing a telephone call from a calling party landline phone.

4. The method of claim 1 wherein the step of providing includes providing a visual time or time zone indication on the calling party phone.

5. The method of claim 1 wherein the step of providing includes providing on the calling party phone an audible warning of a time zone difference between that of the calling party and called party.

6. The method of claim 1 wherein the step of providing includes providing a time indication of the local time of the called party on the calling party phone.

7. The method of claim 1 including the step of optionally completing the telephone call from the calling party to the called party after receipt of the time difference indication.

8. The method of claim 1 including the step of determining the time difference between the local time of the called party and the local time of the calling party.

9. The method of claim 1 wherein the receiving step includes receiving at the calling party phone the data representing the time difference between the local time of the called party and the local time of the calling party only if the time difference is greater than a predetermined time difference.

10. A method of notifying a calling party of time difference information comprising the steps of:
placing a telephone call from a calling party phone to a cell phone of a called party;
receiving at the wireless carrier serving the then location of the called party the call from the calling party;
sending to the calling party phone from the wireless carrier serving the then location of the called party, time difference data representing the difference between the local time at the called party location and the local time of the calling party location; and
providing to the calling party a time difference indication based on the time difference data.

11. The method of claim 10 wherein the sending step includes sending to the calling party phone time difference data only if the local time at the called party phone location is greater than a predetermined time difference from the local time at the calling party phone location.
